(19) United States
(12) Patent Application Publication
(10) Pub. No.: US 2015/0020504 A1
(43) Pub. Date: Jan. 22, 2015

(54) EXHAUST FLOW ESTIMATION

(71) Applicant: International Engine Intellectual Property Company, LLC, Lisle, IL (US)

(72) Inventors: Jacques Florian Nicole, Palo Alto, CA (US); Rade Milanovic, Oak Park, CA (US); Evan Ngan, San Jose, CA (US); Little Flower Basani, Aurora, IL (US)

(21) Appl. No.: 13/946,148

(22) Filed: Jul. 19, 2013

(51) Int. Cl. F01N 11/00; G01N 15/08; F01N 3/021

(52) U.S. Cl. CPC F01N 11/002; F01N 3/021; G01N 15/0826
USPC 60/274; 60/277; 60/311; 73/38

(57) ABSTRACT

The present technology provides systems for monitoring particulate matter buildup on a filter installed in the engine exhaust stream of a vehicle. A filter differential pressure sensor monitors a pressure differential across the filter. A downstream differential pressure sensor monitors a pressure differential across an exhaust stream outlet. A processor monitors a particulate buildup value based at least in part on the pressure differential across the filter and the pressure differential across the exhaust stream outlet. A method for monitoring particulate buildup is also provided. The method monitors a pressure differential across the filter, and determines a downstream exhaust flow rate based on a pressure differential between a filter outlet housing and an exit pipe, where the diameter of the filter outlet housing is greater than the diameter of the exhaust exit pipe.

### BACKGROUND

Environmental policies encourage a reduction in the level of emissions that are generated by engines for motor vehicles. Indeed, governmental regulations have been implemented that set emission requirements for motor vehicles. As a result of these policies and regulations, new vehicles are being produced with built-in systems and devices that control and reduce the amount of particulate matter expelled in a vehicle's exhaust stream. However, older vehicles that were not built with these environmental policies in mind may not be able to meet the emissions regulations without modification. Accordingly, the older, in-use vehicles can benefit from having emission reducing systems retrofitted onto the vehicle.

One method currently used to reduce emissions generated by a diesel engine is to install a diesel particulate filter (“DPF”) in the exhaust stream of a diesel engine. A DPF collects particulate matter in the diesel exhaust stream, thereby helping to maintain the vehicle emissions at appropriate levels. However, if a significant amount of particulate builds up on the DPF, it can affect or limit the ability of the DPF to reduce emissions, and can even affect the operation of the engine.

To help control the buildup of particulate matter, a DPF is often installed in conjunction with a diesel oxidation catalyst (“DOC”) system. The DOC system reduces excess hydrocarbon and carbon monoxide emissions and increases the exhaust gas temperature. In this manner, when the buildup of particulate matter on a DPF has reached a significant level, the vehicle operator can effectively regenerate or clean the DPF by operating the engine at a level that sufficiently elevates the exhaust stream temperature. Alternatively, a user can manually service, repair, or even replace a filter if the particulate buildup has reached a level that can affect the efficiency and performance of the DPF. Accordingly, an efficiently functioning DPF depends on the ability to accurately monitor the level of particulate buildup on the filter.

### SUMMARY

One or more aspects of the present technology relate to systems for monitoring particulate matter buildup (“particulate buildup”) on a filter installed in the engine exhaust stream of a vehicle. In certain embodiments, the system comprises a filter differential pressure sensor to monitor a pressure differential across the filter, and a downstream differential pressure sensor that monitors a pressure differential across an exhaust stream outlet. The system also comprises a processor that calculates a particulate buildup value based at least in part on the pressure differential across the filter and the pressure differential across the exhaust stream outlet.

Certain aspects of the present technology relate to methods for monitoring particulate buildup on a filter in an engine exhaust stream. The method monitors a pressure differential across the filter using a filter differential pressure sensor. The method also monitors a downstream pressure differential between a filter outlet housing and an exhaust exit pipe using a downstream differential pressure sensor, where the diameter of the filter outlet housing is greater than the diameter of the exhaust exit pipe. A downstream exhaust flow rate is calculated based on the downstream pressure differential, and a particulate buildup value is calculated based on the monitored pressure differential across the filter and the monitored downstream exhaust flow rate.

Certain aspects of the present technology also provide a retrofit filter system for installation in the exhaust stream of a vehicle having a diesel engine. The retrofit filter system has a DPF having a filter outlet housing. The retrofit filter system also has a downstream exit pipe having a diameter that is less than the diameter of the filter housing outlet. The system has at least one temperature sensor that measures the temperature of the exhaust stream. The system also comprises a filter differential pressure sensor that monitors a pressure differential across the filter, and a downstream differential pressure sensor that monitors a pressure differential across an exhaust stream outlet. The retrofit filter system also has a processor that monitors the particulate buildup on the filter based at least in part on the exhaust stream temperature, pressure differential across the filter and the pressure differential across the exhaust stream outlet.

### BRIEF DESCRIPTION OF THE DRAWINGS

FIG. 1 depicts a retrofit filter system installed in the exhaust stream of a vehicle.

FIG. 2 depicts a retrofit filter system for installation in the exhaust stream of a vehicle.

FIG. 3 depicts a close up view of a filter housing used in a filter system installed in the exhaust stream of a vehicle.

FIG. 4 is a flow diagram of a method for monitoring particulate buildup on a filter in an engine exhaust stream.

FIG. 5 is a graph that charts soot loading across pressure drop at three different exhaust flow rates.

### DETAILED DESCRIPTION

The present technology presents methods and systems for monitoring buildup on an engine exhaust filter. In particular, the present technology provides methods and systems that monitor the exhaust stream temperature and flow rate over a filter that has been retrofitted into the exhaust stream of a motor vehicle. Based on these values, the amount of particulate buildup on the filter can be estimated and/or calculated.

Older vehicles that were not designed to meet present-day emissions standards can be retrofitted with a filter system (e.g., a DPF) that help control emissions and reduce the amount of particulate expended into the environment. These retrofit filter systems can be installed in the exhaust stream of a vehicle and collect particulate that would otherwise be emitted into the environment. As previously noted, retrofitted filter systems can be installed with an oxidation catalyst system, for example a DOC system that helps burn off particulate when the exhaust stream temperature is elevated. In this manner, a vehicle operator can effectively control the amount of particulate that accumulates on a filter by operating the engine at a level that sufficiently regenerates or cleans the filter, or by having the filter repaired or replaced. It is therefore useful to continually monitor the amount of particulate that builds up on a filter in a filter system. The particulate buildup level can be monitored, calculated and/or estimated if the exhaust stream temperature and the exhaust stream flow rate across the filter are monitored over time.

Monitoring the exhaust stream flow rate over the filter of a retrofitted filter system, however, can be a difficult task. One reason for this is because retrofitted filter systems do not easily engage with the communication protocols of the engine or the engine control unit (“ECU”). Therefore, a retrofitted filter system is typically blind to valuable information that relates to engine speed, idle times, and other information that can be used to calculate exhaust flow rates.

Designing and installing a retrofit filter system that can communicate with an ECU is complicated, difficult and expensive. For example, every installer would have to be educated in a broad array of vehicle systems, including the exhaust lines and engine electrical lines for all vehicle builds and types. Furthermore, installation poses a risk that can result in the accidental cutting of lines relating to other significant vehicle functions. Additionally, even if a retrofit filter system is properly installed to communicate with an ECU, it can be difficult to test the accuracy of the communication. And depending on the ECU, certain information, such as the exhaust flow rate, may still not be available. For these and other reasons, it is typically not worth the time, labor and money to install a retrofit filter system that is capable of communicating with an ECU. Accordingly, it can be useful to have a retrofit filter system that is capable of monitoring particulate buildup on a filter without an ECU connection.

A retrofitted filter system can be designed to estimate or calculate the particulate buildup on the filter in several ways. The filter system may include equipment, such as sensors that obtain information allowing for the estimation and/or computation of the particulate buildup level. For example, a system can include a crankshaft position sensor, which measures the speed of the engine, a new intake mass air flow (“MAF”) sensor, which measures the intake air flow, a backpressure sensor, which measures the pressure upstream of the filter, and a temperature sensor, which measures an inlet temperature of the filter system.

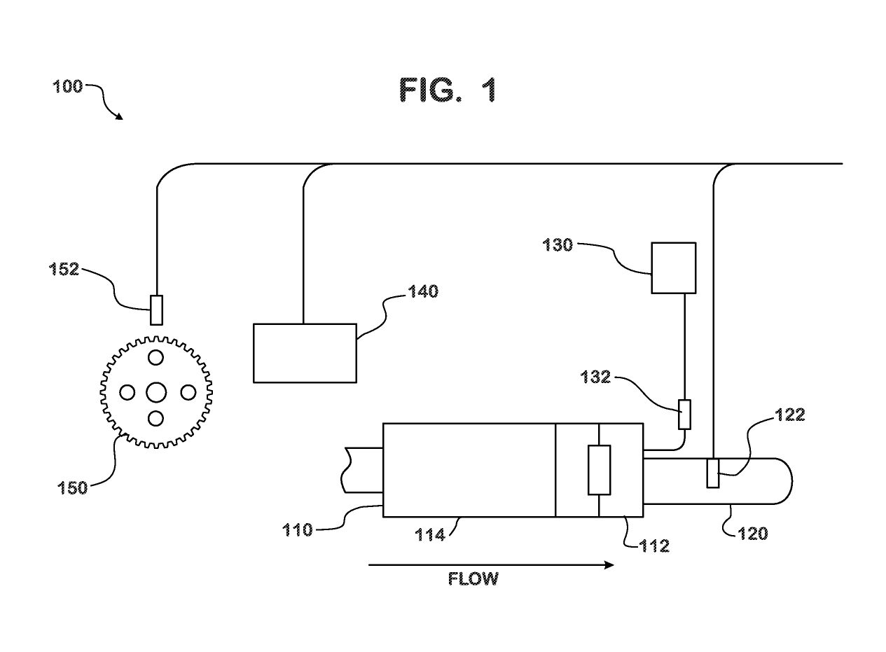

FIG. 1 depicts a filter system 100, particularly a DPF system, retrofitted in the exhaust stream 110 of a vehicle. Filter system 100 uses a crankshaft position sensor 152 and an intake MAF sensor 140, to monitor the particulate buildup on a filter 112 as described above. The filter 112 is installed in the exhaust stream 110. In certain aspects the filter 112 is a DPF, and has a larger diameter than the diameter of the filter outlet 120. This difference in diameters between the filter 112 and the filter outlet 120 creates a flow restriction in the form of a pressure drop across the outlet of the filter 112. An oxidation catalyst system 114, particularly a DOC, is upstream (in the direction of exhaust flow) of the filter 112. When the exhaust stream temperature is sufficiently high, particulate and/or soot that built up on the filter 112 is oxidized or burned off, thereby cleaning and regenerating the filter 112.

A temperature sensor 122 (e.g., a thermocouple), is installed in the exhaust stream to measure the exhaust stream temperature. A pressure sensor 132 measures the pressure differential (or pressure drop) across the filter 112. In certain aspects of the present technology, both the thermocouple and the pressure sensor are located downstream of the DOC, and upstream from the turbocharger of the engine. A processor or control module 130 can communicate with the various sensors of the system 110 and send signals to the vehicle operator relating to the status of the filter. For example, if the control module 130 determines that the particulate buildup on the filter 112 has reached a predetermined level, the control module 130 may send a signal notifying the operator to operate the engine to regenerate the filter, or to replace or repair the filter.

In certain embodiments, the filter system includes an intake MAF sensor 140 mounted to the intake of the engine. The intake MAF sensor 140 senses the flow going into the engine. A crankshaft 150 and a crankshaft position sensor 152 can also be used in the filter system 110. The crankshaft position sensor 152 uses a magnet to monitor the moving teeth of the crankshaft, thereby calculating the speed of the engine. With the speed of the engine known, and the intake MAF sensor also known, the system 100 can determine the exhaust stream flow rate, and thereby monitor the particulate buildup on the filter 112.

The information obtained from the crankshaft position sensor 152, the MAF sensor 140, the temperature sensor 122 and/or the pressure sensor 132 can be loaded into an algorithm that determines an exhaust flow rate and/or a particulate load on the filter. The system could then notify the vehicle operator if it is determined that excessive particulate, or soot has built up on the filter. However, aftermarket dealers or installers may find it difficult to install or retrofit a system with a crankshaft position sensor 142 and an intake MAF sensor 140. For example, installers may not have experience and/or training in installing an intake MAF sensor 140 or a crankshaft position sensor 152. Additionally, these items may also be difficult to install due to limited available space in the engine. Accordingly, the present technology provides alternative ways to monitor particulate buildup on a filter.

Other methods for monitoring the exhaust flow rate or particulate buildup include the installation of a pitot probe at the outlet of the exhaust system. A pitot probe, or pitot tube, is a pressure measuring device used to measure fluid flow velocity. However, use of a pitot probe is less than ideal for several reasons. First, the installation of a pitot probe at the outlet of an exhaust system may not provide the exhaust flow rate across the filter itself with sufficient accuracy. Pitot probes also introduce problems because they can become clogged by engine exhaust and soot particles. Additionally, pitot probes can be expensive, and difficult to install and use.

Another method may involve using a venturi device in the exhaust flow stream that measures the exhaust flow rate. In use, a venturi device introduces a restriction on the exhaust flow by narrowing the exhaust flow path. Through this restriction, the venturi device can calculate an exhaust flow rate. However, using a venturi device can present issues. First, making and installing a venturi device can be difficult, time consuming, and expensive. Furthermore, because a venturi device introduces a new restriction into the exhaust flow stream that is not otherwise present, it can create back pressure on the engine, which may lead to additional engine problems, for example, and reduce the engine efficiency.

Yet another method involves estimating the exhaust flow rate using statistics and existing sensors, rather than measuring the flow rate with added sensors and/or equipment. For example, one could obtain a series of flow rate measurements for one engine using a backpressure sensor and a temperature sensor. In this manner, a system could calibrate its sensors (e.g., temperature sensors and backpressure sensors) and associate various measured flow rates with particular sensor readings. An exhaust flow rate can be estimated, therefore, based on previously determined flow rates at the same or similar temperatures and pressure values. This technique operates under the assumption that the exhaust flow rate will be the same for all engines at a particular set of sensor reading. Such an assumption can result in inaccurate estimates, however, because it does not account for variables such as the engine type, the exhaust pipe configurations (e.g., pipe bends, pipe reductions), and fluctuating external conditions, for example.

The present technology provides a solution that utilizes sensors that are cost effective, accurate, and easy to install without introducing additional unnecessary pressure restrictions into the exhaust system, and without the use of information from an ECU. The present technology uses a flow restriction already present in the exhaust filter system. This restriction, which is created by a step-down at the outlet of a filter (e.g., a DPF) can diameter, is used to measure the exhaust flow rate. Once the exhaust flow rate has been determined, it can be implemented into a particulate (or soot) loading algorithm and create a more accurate model to warn the driver of the state of the filter buildup.

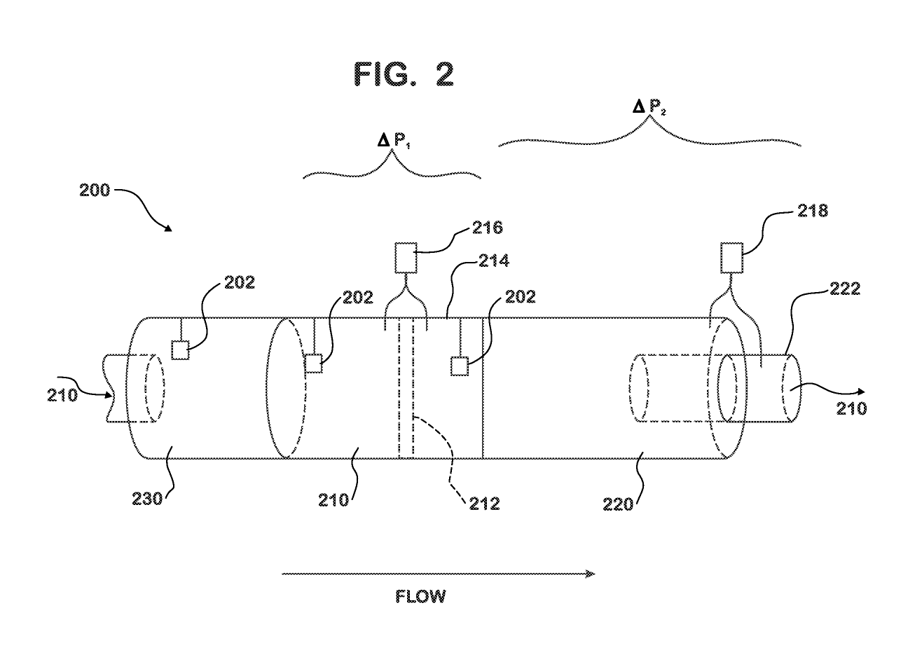

FIG. 2 depicts a retrofit filter system 200 for installation into the exhaust stream 210 of a vehicle, that monitors the particulate buildup on a filter 212. The filter system 200 provides a flow restriction in the form of a flow diameter step-down, which allows for the measurement of a downstream pressure differential. Knowing the downstream pressure differential and the exhaust stream temperature, the system can determine the exhaust stream flow rate.

The system 200 includes a filter housing 214, which houses the filter 212. Filter 212 may be, for example, a DPF. In certain embodiments of the present technology, DPF can be a retrofit DPF system installed onto a vehicle having a diesel engine. The filter system 200 can include a processor (not shown), which may be a computer processor or a control module, for example. The processor is electrically connected to the various sensors in the filter system 200 so that the sensors can communicate their readings to the processor accordingly.

Located upstream (in the direction of exhaust flow) from the filter 212 is an oxidation catalyst system 230, in particular, a DOC. The DOC 230 releases high temperature gas that can oxidize particulate that has built up on the filter 212 when the exhaust stream temperature is elevated to certain temperatures.

The system includes one or more temperature sensors 202 that monitor the temperature of the exhaust stream 210. The temperature sensors 202 can be located at various locations throughout the exhaust stream 210, but are typically situated between the DOC 230 and the turbocharger of the engine (not shown). In FIG. 2, the temperature sensors are located at the inlet of the DOC 230, the outlet of the DOC 230, and just downstream of the filter 212. Though three temperature sensors 202 are shown, the present technology may operate with only one temperature sensor 202, two temperature sensors 202, or more than three sensors 202. In certain embodiments, the temperature sensor 202 is a thermocouple, for example.

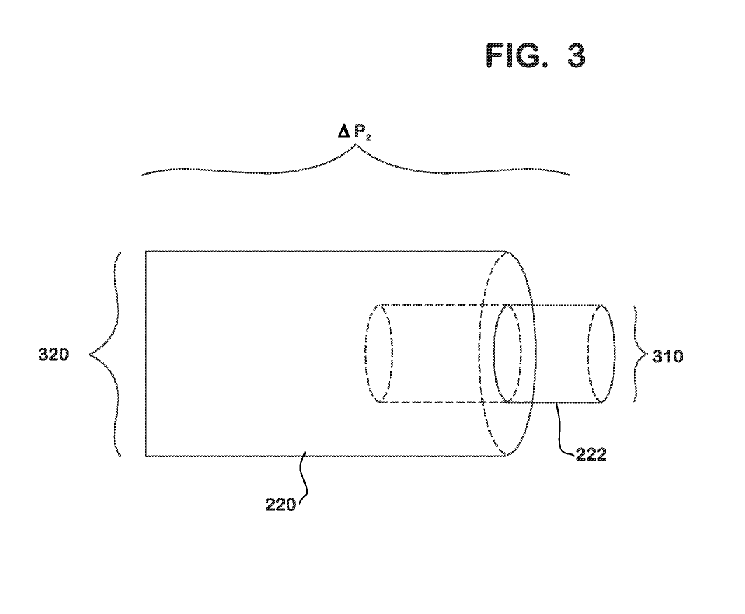

Filter outlet housing 220 is located between the filter 212 and the exhaust exit pipe 222. The filter outlet housing 220 is located downstream from the filter housing 214, and flows into the exit pipe. As shown in FIG. 2, and further magnified in FIG. 3 (which depicts a blown-up view of the filter outlet housing 220 and the exit pipe 222), the diameter 320 of the filter outlet housing 220 is greater than the diameter 310 of the exit pipe. In certain embodiments of the present technology, the diameter of the filter outlet housing 220 is about 12 inches, and the diameter of the exit pipe 222 is about 5 inches. However, the diameters of the filter outlet housing 220 and the exit pipe 222 can vary depending on the vehicle and the filter system 200, but the filter outlet housing diameter 220 will be greater than the exit pipe 222 diameter to create restriction in the exhaust flow. This diameter step-down creates a flow restriction in the exhaust stream, and allows for a pressure differential reading to be taken at that point.

Downstream differential pressure sensor 218 is located across the restriction in the outlet and allows the system 200 to monitor the downstream pressure differential (ΔP₂). Based on the measured downstream pressure differential (ΔP₂), an exhaust stream flow rate can be determined For example, the processor can be used to calculate a downstream exhaust flow rate using a flow rate algorithm. In certain embodiments, the flow can be calculated using a pre-determined model based on actual experimental flows and temperatures. In general, the greater the accuracy of the downstream differential pressure sensor, the more accurate the system 200 will be at monitoring the particulate buildup on the filter 212

Referring again to FIG. 2, a filter differential pressure sensor 216 monitors a pressure differential (ΔP₁) that occurs across the filter 212. As noted above, the processor can calculate and monitor the exhaust flow rate based on the downstream pressure differential and the exhaust temperature. With knowledge of the exhaust flow rate, the system can calculate a hypothetical corresponding pressure drop across a clean filter. For example, the processor can apply a model based on Darcy's law, or use an experimental calibration to determine a hypothetical clean filter pressure drop based on the filter properties (e.g., filtration level, filter size, etc.). The hypothetical clean filter pressure drop can be then compared to the actual pressure differential measured across the filter (ΔP₁). The difference between the actual and the calculated pressure drop can be used to determine the particulate buildup on the filter 212. In other words, the difference between the actual pressure differential across the filter 212 and the hypothetical clean pressure drop can be proportional to the particulate buildup on the filter. The processor can determine the particulate buildup level using a pre-determined algorithm, for example.

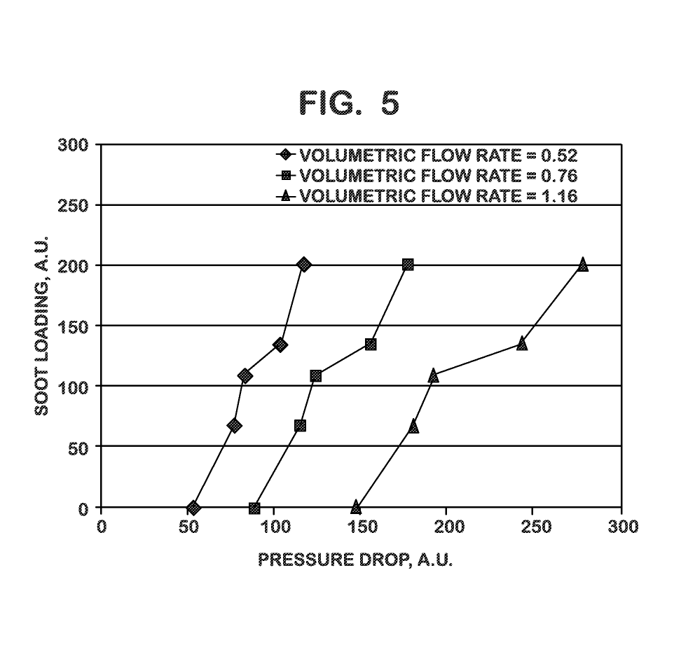

FIG. 5 is a graph that charts soot loading (i.e., particulate buildup) across pressure drop at three different exhaust flow rates based on experimental results. As shown in FIG. 5, at a known exhaust flow rate, there is a trend between the particulate buildup level and the pressure drop measured across the filter. In FIG. 5, the experimental results indicate that, for a given exhaust flow rate, a larger pressure drop indicates a greater amount of particulate buildup. This type of experimental result information can be used, for example, to build an algorithm that can calculate particulate buildup across a wide array of exhaust flow rates and measured pressure drops.

In certain embodiments of the present technology, the system 200 may include an absolute backpressure sensor (not shown) that monitors the backpressure value of the filter system 200. However, because the system uses two differential pressure sensors 216 and 218, the system does not need to consult with the backpressure sensor, which may not provide as accurate of measurements. For example, the engine backpressure sensor measurement can be subject to variation of the pressure drop through the DOC. Moreover, the variation in exhaust pipe configurations can affect the backpressure; therefore, backpressure sensor calibrations will vary depending on the vehicle.

In certain embodiments of the present technology, the system 200 transmits a signal to an operator of the vehicle when the particulate buildup value is greater than a predetermined threshold. For example, if the system recognizes that the difference between the hypothetical clean filter pressure drop and the actually measured filter pressure differential is greater than a predetermined value, the system 200 (via the processor, control module, or computer, e.g.) may generate a signal notifying the vehicle operator. The signal may notify the operator to change the filter, repair the filter, or operate the engine at a level to elevate the exhaust stream temperature to clean the filter, for example. Additionally and/or alternatively, the system 200 may generate a variety of signals, corresponding to different levels of particulate buildup. For example, the system 200 may generate a signal reading that continually provides the particulate buildup level, even where the particulate buildup has not reached a significant level. For example, the system 200 may generate an analog signal that indicates the particulate buildup level against a backdrop of “low,” “medium,” or “high” buildup. In certain aspects of the present technology, the system 200 can generate a signal that quantifies the particulate buildup level, for example, based on mass or volume of particulate, or a percentage of the storage capacity of the filter.

Because the present technology is designed to work with retrofit filter systems, system 200 is capable of monitoring particulate buildup without being electrically connected to an ECU of a vehicle.

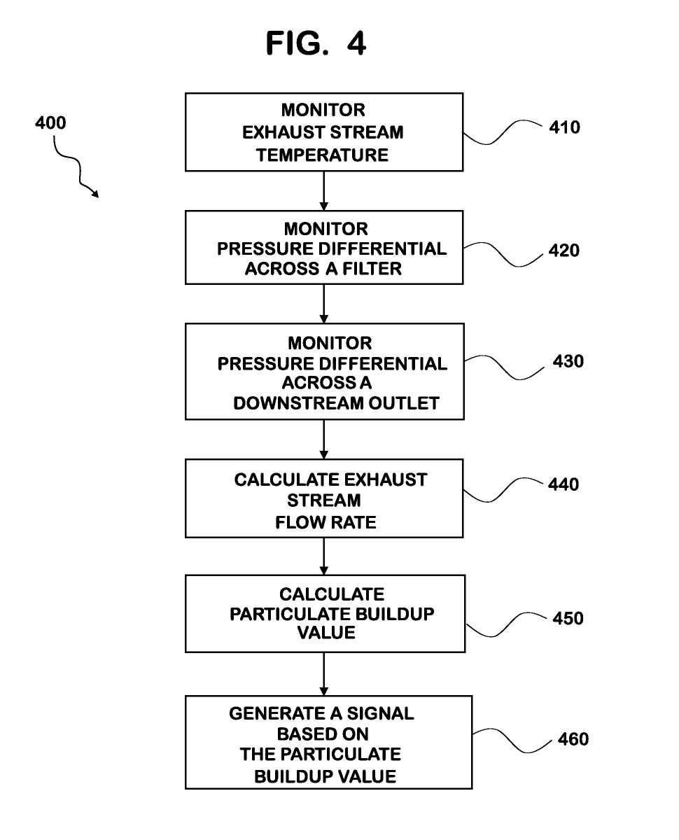

The present technology also provides methods for monitoring particulate buildup on a filter in a retrofit filter system that has been installed in an engine exhaust stream. FIG. 4 depicts a flow diagram of a method 400 for monitoring particulate buildup on a filter in an engine exhaust stream. At step 410, the method monitors the temperature of the exhaust stream. The temperature may be monitored by the use of one or more temperature sensors (e.g., a thermocouple), positioned in the exhaust stream. The temperature sensors may be installed in a retrofitted filter system installed onto a vehicle. In certain embodiments, at least one of the temperature sensors is located downstream from a DOC, and upstream from the turbocharger of the engine.

The method further includes monitoring a pressure differential across a filter at step 420. The method may use a filter differential pressure sensor that monitors the pressure drop that occurs over the filter. The filter pressure differential sensor may also be in communication with the computer processor.

At step 430, the method monitors the pressure differential across a downstream outlet using a downstream differential pressure sensor. As noted above, the presently described method is applied to a retrofit filter system that has been installed in the engine exhaust stream of a vehicle. Accordingly, the method can use the flow restrictions that exist in the retrofit filter system to measure pressure drops. For example, in certain embodiments of the present technology, the retrofit filter system includes a filter outlet housing that flows into an exit pipe, where the diameter of the filter outlet housing is greater than the diameter of the exit pipe. In certain embodiments of the present method, the filter outlet housing has a diameter of about 12 inches, and the exhaust exit pipe has a diameter of about five inches. The differences between the diameters of the exit pipe and the filter outlet housing create a pressure drop that can be measured by the downstream differential pressure sensor. As with the filter differential pressure sensor of step 420, the downstream differential pressure sensor can also be in communication with the computer processor.

The method further includes calculating the exhaust stream flow rate at step 440. The exhaust stream flow rate can be calculated, for example, based on the pressure differential across the downstream outlet. For example, if the diameters of the filter outlet housing and the exit pipe are known, then an exhaust stream flow rate can be calculated, for example, by the computer processor using the measured downstream pressure differential and the exhaust stream temperature.

At step 450, a particulate buildup value is determined In certain embodiments the particulate buildup value is calculated by the computer processor based on the exhaust stream flow rate and the exhaust stream temperature over time. In certain embodiments the method generates a hypothetical clean filter pressure drop value based upon the monitored exhaust stream flow rate determined at step 440 and/or known properties of the filter. For example, the method can apply a model based on Darcy's law or use experimental calibration to determine a pressure drop that would be expected across a clean filter. The hypothetical clean filter pressure drop value represents the estimated pressure drop expected to occur over a clean filter with no particulate buildup at a known exhaust flow rate. The hypothetical clean filter pressure differential value can then be compared with the actual pressure drop measured obtained in step 420. A particulate buildup value can then be determined based on the difference between the actual filter pressure differential and the hypothetical clean filter pressure differential value. In certain embodiments, the differential pressure signals can be electronically filtered (e.g., at step 430) to reduce the noise and improve the accuracy of the particulate buildup calculation.

At step 460, a signal is transmitted relating to the particulate buildup value. For example, a signal may be transmitted to a vehicle operator informing the operator that the filter should be cleaned, regenerated, repaired or replaced. In certain embodiments, if the difference between the hypothetical clean filter pressure drop and the actually measured filter pressure drop is greater than a predetermined value, the system the computer processor or control module can generate a signal notifying a vehicle operator. Additionally and/or alternatively, a variety of signals corresponding to different levels of particulate buildup can be generated. For example, the method may involve generating a signal that continually notifies the user of the particulate buildup level. For example, the signal may continually indicate whether the particulate buildup level is “low,” “medium,” or “high.” In certain embodiments, the signal quantifies the particulate buildup level.

The present method can be applied to a retrofit diesel particulate filter system that is installed onto a vehicle having a diesel engine. For example, the mufflers of a retrofit vehicles can be replaced by a retrofit DPF system of the present technology.

Because the method determines the exhaust stream flow rate using a downstream differential pressure sensor, the presently described technology can monitor the particulate buildup on a DPF without being in electrical connection to the vehicle ECU. The present technology also monitors particulate buildup without the need to use less accurate backpressure sensors. The present technology also allows a processor or control module to warn vehicle operators of particulate buildup on a filter without creating an additional pressure drop in the pressure system.

The present technology has now been described in such full, clear, concise and exact terms as to enable any person skilled in the art to which it pertains, to practice the same. It is to be understood that the foregoing describes embodiments and examples of the present technology and that modifications may be made therein without departing from the spirit or scope of the technology as set forth in the claims. Moreover, it is also understood that the embodiments shown in the drawings, if any, and as described above are merely for illustrative purposes and not intended to limit the scope of the technology.

1. A system for monitoring particulate buildup on a filter installed in the engine exhaust stream of a vehicle comprising:
a filter differential pressure sensor to monitor a pressure differential across the filter;
a downstream differential pressure sensor to monitor a pressure differential across an exhaust stream outlet; and
a processor;
wherein the processor calculates a particulate buildup value based at least in part on the pressure differential across the filter and the pressure differential across the exhaust stream outlet.

2. The system of claim 1, further comprising a temperature sensor to monitor an exhaust stream temperature, wherein the processor calculates the particulate buildup value based further upon the exhaust stream temperature.

3. The system of claim 1, wherein the processor transmits a signal to an operator of the vehicle based on the particulate buildup value.

4. The system of claim 1, wherein the filter is a retrofit diesel particulate filter installed onto a vehicle having a diesel engine.

5. The system of claim 1, wherein the system is not electrically connected to an engine control unit of the vehicle.

6. The system of claim 1, wherein the system further comprises a filter outlet housing between the filter and an exhaust exit pipe, and the downstream differential pressure sensor monitors a pressure differential between the filter outlet housing and the exhaust exit pipe, wherein the diameter of the filter outlet housing is greater than the diameter of the exhaust exit pipe.

7. The system of claim 6, wherein the diameter of the filter outlet housing is about 12 inches, and the diameter of the exhaust exit pipe is about 5 inches.

8. A method for monitoring particulate buildup on a filter in an engine exhaust stream comprising:
monitoring a filter pressure differential across a filter using a filter differential pressure sensor;
monitoring a downstream pressure differential between a filter outlet housing and an exhaust exit pipe using a downstream differential pressure sensor;
calculating a downstream exhaust flow rate based on the downstream pressure differential; and
calculating a particulate buildup value based on the monitored filter pressure differential and the monitored downstream exhaust flow rate;
wherein the diameter of the filter outlet housing is greater than the diameter of the exhaust exit pipe.

9. The method of claim 8, further comprising the step of monitoring the temperature of the exhaust stream, wherein the exhaust stream flow rate across is determined at least in part upon the monitored exhaust stream temperature.

10. The method of claim 9, wherein the monitoring the temperature step involves using a thermocouple positioned in the exhaust stream.

11. The method of claim 8, wherein the filter is a retrofit diesel particulate filter installed onto a vehicle having a diesel engine.

12. The method of claim 8, wherein the diameter of the filter outlet housing is about 12 inches, and the diameter of the exhaust exit pipe is about 5 inches.

13. The method of claim 8, wherein the step of calculating a particulate buildup value is performed without interacting with an engine control unit of the engine.

14. The method of claim 8, further comprising the step of transmitting a signal relating to the calculated particulate buildup value.

15. A filter system for installation in the exhaust stream of a vehicle having a diesel engine, the filter system comprising:
a diesel particulate filter having a filter outlet housing;
a downstream exit pipe having a diameter less than the diameter of the filter outlet housing;
a temperature sensor to monitor the temperature of the exhaust stream;
a filter differential pressure sensor to monitor a pressure differential across the filter;
a downstream differential pressure sensor to monitor a pressure differential across an exhaust stream outlet; and
a processor;
wherein the processor calculates a particulate buildup value on the filter based at least in part on the temperature of the exhaust stream, the pressure differential across the filter, and the pressure differential across the exhaust stream outlet.
